(19) United States
(12) Patent Application Publication
(10) Pub. No.: US 2012/0162444 A1
(43) Pub. Date: Jun. 28, 2012

(54) INFORMATION PROVIDING SYSTEM

(75) Inventor: Yasushi Suda, Nagoya (JP)

(73) Assignee: ELMO COMPANY, LIMITED, Nagoya (JP)

(21) Appl. No.: 13/329,784

(22) Filed: Dec. 19, 2011

(30) Foreign Application Priority Data
Dec. 24, 2010 (JP) 2010-288076

(51) Int. Cl. H04N 5/225

(52) U.S. Cl. 348/207.1; 348/E05.024

(57) ABSTRACT

An information providing system includes an information providing device and a tablet terminal. The information providing device wirelessly sends first information including a taken image, to the tablet terminal; wirelessly receives second information including information regarding a user's drawing operation on the table terminal, from the table terminal; and displays a drawn image corresponding to the user's drawing operation to be superimposed on the taken image, as a displayed image on a display, based on the second information. The tablet terminal includes an operation unit having an operating surface, on which the user performs the drawing operation. The tablet terminal wirelessly sends the second information to the information providing device, based on the user's drawing operation; wirelessly receives the first information from the information providing device; and displays a composite image including the drawn image superimposed on the taken image, on the operating surface, based on the first information.

### CROSS-REFERENCE TO RELATED APPLICATION

The present application claims priority from Japanese application P2010-288076A filed on Dec. 24, 2010, the content of which is hereby incorporated by reference into this application.

### FIELD OF INVENTION

The present invention relates to an information providing system including an information providing device and a tablet terminal.

### BACKGROUND

Recently, information providing devices have widely been used for presentations. The known technology relating to the information providing devices includes, for example, the technology disclosed in JP 2010-245690.

A pointing device used for operating the information providing device, especially a tablet terminal used for performing a drawing operation on a displayed image or for specifying the position on the displayed image, however, has only the insufficient operability. For example, the user is required to operate the tablet terminal at hand for the drawing operation, while checking the displayed image on a distant display device, such as a television set or a projector. The user may accordingly have difficulties in performing a desired drawing operation on the displayed image and specifying the position on the displayed image. Improvement of the operability of the tablet terminal has thus been demanded.

### SUMMARY

Consequently, in order to address the problem described above, there is a need to improve the user's operability of a tablet terminal for the information providing device.

In order to achieve at least part of the foregoing, the present invention provides various aspects and embodiments described below.

According to a first aspect of the invention, there is provided an information providing system including an information providing device equipped with a camera and a tablet terminal for displaying images. The information providing device comprises: a single housing; an imaging unit configured to take an image of a preset area with the camera and obtain the taken image; a first information transmitter configured to wirelessly send first information including the taken image, to the tablet terminal; a second information receiver configured to wirelessly receive second information including information regarding a user's drawing operation on the table terminal, from the table terminal; and a display output module configured to display a drawn image corresponding to the user's drawing operation to be superimposed on the taken image, as a displayed image on a display, based on the second information, wherein the imaging unit, the first information transmitter, the second information receiver and the display output module are all accommodated in the single housing. The tablet terminal comprises: an operation unit having an operating surface, on which the user performs the drawing operation; a second information transmitter configured to wirelessly send the second information to the information providing device, based on the user's drawing operation; a first information receiver configured to wirelessly receive the first information from the information providing device; and an image display module configured to display a tablet displayed image, which includes the drawn image superimposed on the taken image, on the operating surface, based on the first information.

The information providing system according to this aspect displays the tablet displayed image including the drawn image superimposed on the taken image on the operating surface of the tablet terminal. This enables the user to perform the drawing operation, while checking the tablet displayed image at hand, thus improving the user's operability of operating the information providing device via the tablet terminal.

According to one embodiment of the invention, there is provided the information providing device, wherein the second information transmitter may send the drawn image as the second information to the information providing device. The image display module may comprise a tablet displayed image generator configured to generate a composite image including the drawn image superimposed on the taken image, as the tablet displayed image. The information providing device may further comprise a received drawn image storage configured to store the drawn image received by the second information receiver. The display output module may comprise a displayed image generator configured to generate a composite image including the drawn image superimposed on the taken image, as the displayed image.

In the information providing system according to this embodiment, the information providing device and the tablet terminal individually perform the process of generating the composite image including the drawn image superimposed on the taken image. There is accordingly no need to wirelessly send and receive the composite image of the drawn image with the taken image as the first information or as the second information. This advantageously reduces the data volume to be transferred.

According to another embodiment of the invention, there is provided the information providing device, wherein the tablet displayed image generator may comprise: a block image storage configured to divide each area of the operating surface into a plurality of blocks and store the drawn image as a set of block images of the respective blocks; and a tablet block updater configured to update a block image for a changed block having a change of the drawn image by the user's drawing operation, which is stored in the block image storage, to a corresponding changed block image reflecting the change. The second information transmitter may send a block image for the changed block as the second information to the information providing device. The received drawn image storage stores the drawn image as a set of the block images. The information providing device may further comprise an information providing device block updater configured to, in response to reception of a block image as the second information, update the drawn image stored in the received drawn image storage, based on the received block image.

In the information providing system according to this embodiment, the block image reflecting the change of the drawn image by the user's drawing operation is sent as the second information from the tablet terminal to the information providing device. This advantageously reduces the data volume to be transferred, compared with the case of sending the whole drawn image as the second information.

According to still another embodiment of the invention, there is provided the information providing device, wherein the first information transmitter may send the first information to the tablet terminal, in response to an acquisition request of the first information from the tablet terminal. The second information transmitter may send the block image for the changed block as the second information to the information providing device, occasionally when the drawn image is changed by the user's drawing operation.

In the information providing system according to this embodiment, the transfer of the first information including the taken image is performed in response to a request from the tablet terminal, whilst the transfer of the block image corresponding to the changed block as the second information is performed occasionally. When the subject imaged by the information providing device does not dynamically change, the transfer of the first information in response to a request from the tablet terminal reduces the number of data transfers without negatively affecting the user's operability. In this information providing system, the block image corresponding to the changed block as the second information is transferred occasionally, so that the displayed image following the user's drawing operation can be displayed on the display of the information providing device and on the operating surface of the tablet terminal.

The present invention may be implemented by diversity of aspects, for example, an information providing method, an information providing device, a presentation system, an integrated circuit or a computer program for implementing the functions of any of the method, the device and the system and a recording medium in which such a computer program is recorded.

### BRIEF DESCRIPTION OF THE DRAWINGS

FIG. 1 illustrates the configuration of an information providing system according to one embodiment of the invention;

FIG. 2 is a block diagram illustrating the internal structure of an information providing device included in the information providing system;

FIG. 3 is a block diagram illustrating the internal structure of a tablet included in the information providing system;

FIG. 4 is a flowchart showing an exemplary flow of drawn image display process;

FIG. 5A, 5B, and 5C illustrate the drawn image display process with a first drawn image;

FIGS. 6A, 6B, and 6C illustrate the drawn image display process with an additional drawn image;

FIG. 7 is a flowchart showing another exemplary flow of drawn image display process according to modification 1;

FIG. 8 is a flowchart showing an exemplary flow of cursor display process according to modification 2; and

FIG. 9 illustrates modification 4.

### DESCRIPTION OF THE EMBODIMENTS

Embodiments of the invention are described, by way of example only, with reference to the accompanying drawings.

### A. First Embodiment

(A1) Configuration of Information Providing System

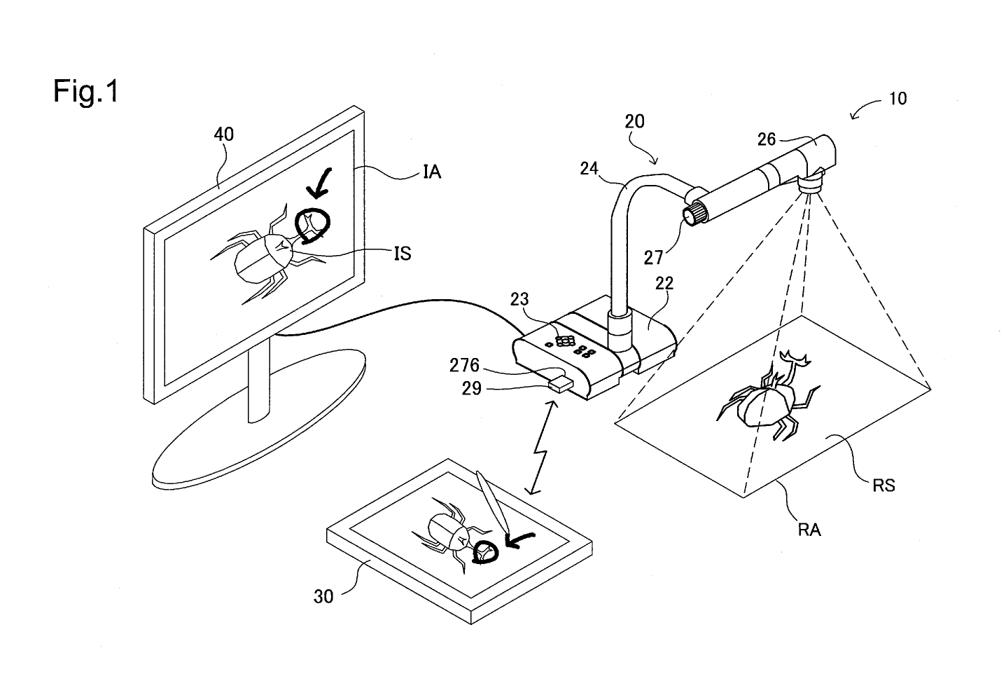

FIG. 1 illustrates the configuration of an information providing system 10 according to one embodiment of the invention. The information providing system 10 includes an information providing device 20, a tablet 30 and a television set 40. The information providing device 20 and the television set 40 are interconnected by a cable for data transfer. The tablet 30 is wirelessly connected with the information providing device 20 by wireless USB. In the information providing system 10, the information providing device 20 takes an image of a material RS placed on an imaging area RA of the information providing device 20 and displays the taken image as a displayed image IA on the screen of the television set 40. A displayed material IS in the displayed image IA corresponds to the material RS.

The information providing device 20 includes a main unit 22 placed on, for example, a desk, an operation unit 23 provided on the main unit 22, a support rod 24 extended upward from the main unit 22, a camera head 26 attached to an end of the support rod 24 and a zoom dial 27. The camera head 26 internally has a CCD video camera and takes images of the material RS placed on, for example, the desk at a preset number of frames per unit time. In this embodiment, the information providing device 20 takes images of the material RS at the rate of 60 frames per second. A transmitter/receiver 29 of the wireless USB for sending and receiving preset data to and from the tablet 30 is connected to a USB interface 276 provided on the main unit 22. Alternatively the transmitter/receiver 29 may be built in the housing of the information providing device 20.

The tablet 30 sends operating information regarding the user's operation performed on the touch panel of the tablet 30 to the information providing device 20 by the wireless USB. The tablet 30 also displays a preset image sent from the information providing device 20 by the wireless USB onto the touch panel of the tablet 30. The information providing device 20 and the tablet 30 transfer the information by the wireless USB according to this embodiment, but may adopt another wireless technology, such as Bluetooth, infrared or wireless LAN, to transfer the information according to other embodiments.

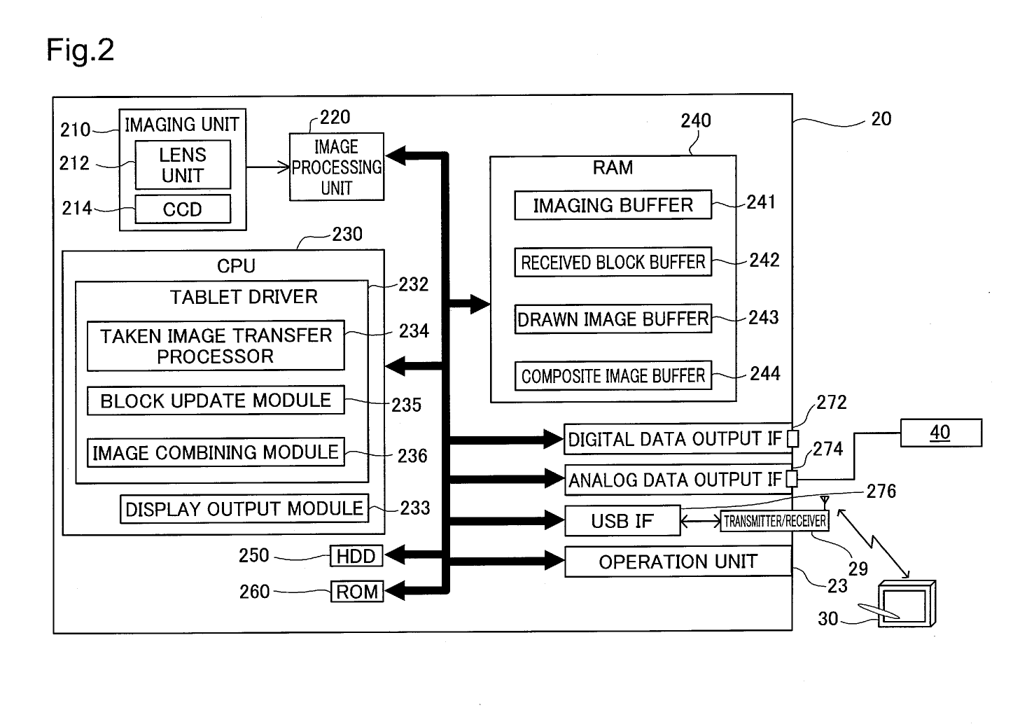

FIG. 2 is a block diagram illustrating the internal structure of the information providing device 20. The information providing device 20 includes an imaging unit 210, an image processing unit 220, a CPU 230, a RAM 240, a hard disk drive (HDD) 250 and a ROM 260. The information providing device 20 also includes a digital data output interface (digital data output IF) 272, an analog data output interface (analog data output IF) 274, the USB interface (USB IF) 276 and the operation unit 23. The transmitter/receiver 29 for sending and receiving preset data to and from the tablet 30, i.e., the transmitter/receiver of the wireless USB, is connected to the USB IF 276.

The imaging unit 210 includes a lens unit 212 and a charge-coupled device (CCD) 214. The CCD 214 serves as an image sensor to receive light transmitted through the lens unit 212 and convert the received light into electrical signal. The image processing unit 220 includes an AGC (Automatic Gain Control) circuit and a DSP (Digital Signal Processor). The image processing unit 220 inputs the electrical signal from the CCD 214 and generates taken image data. The taken image data generated by the image processing unit 220 is stored in an imaging buffer 241 provided in the RAM 240.

The CPU 230 controls the operations of the whole information providing device 20 and reads and executes a program stored in the HDD 250 or the ROM 260 to serve as a tablet driver 232 and a display output module 233. The tablet driver 232 includes a taken image transfer processor 234, a block update module 235 and an image combining module 236, which will be described later in detail.

The RAM 240 includes the imaging buffer 241, a received block buffer 242, a drawn image buffer 243 and a composite image buffer 244. These buffers serve to store required data, which are to be stored during drawn image display process described later and will be described later in detail.

The digital data output IF 272 encodes the taken image data or the composite image data and outputs the encoded image data in the form of digital signal to the outside of the information providing device 20. The analog data output IF 274 processes the taken image data or the composite image data by digital-to-analog conversion and outputs the converted image data in the form of RGB data to the outside of the information providing device 20. The analog data output IF 274 includes a D-A converter (DAC). The digital data output IF 272 and the analog data output IF 274 respectively have a connector for cable connection. In this embodiment, the television set 40 is connected to the analog data output IF 274.

The tablet 30 is described more specifically. The tablet 30 has two modes, i.e., a cursor mode allowing the user to specify a position on the displayed image IA (FIG. 1) and a drawing mode allowing the user to make drawing. The cursor mode displays a cursor at the position on the displayed image IA specified by the user's operation on the tablet 30. The drawing mode enables the user to make drawing on the displayed image IA by the user's operation on the tablet 30. The image taken by the information providing device 20 is also shown on the touch panel of the tablet 30. In the description hereinafter, the image displayed on the touch panel is called “panel image PA”. The user checks the panel image PA and performs the operation of, for example, specifying the position on the displayed image IA and making drawing. The processing result of the user's operation on the tablet 30, e.g., a drawn image by the user's drawing operation, is displayed in real time to be superimposed on the taken image, as the panel image PA.

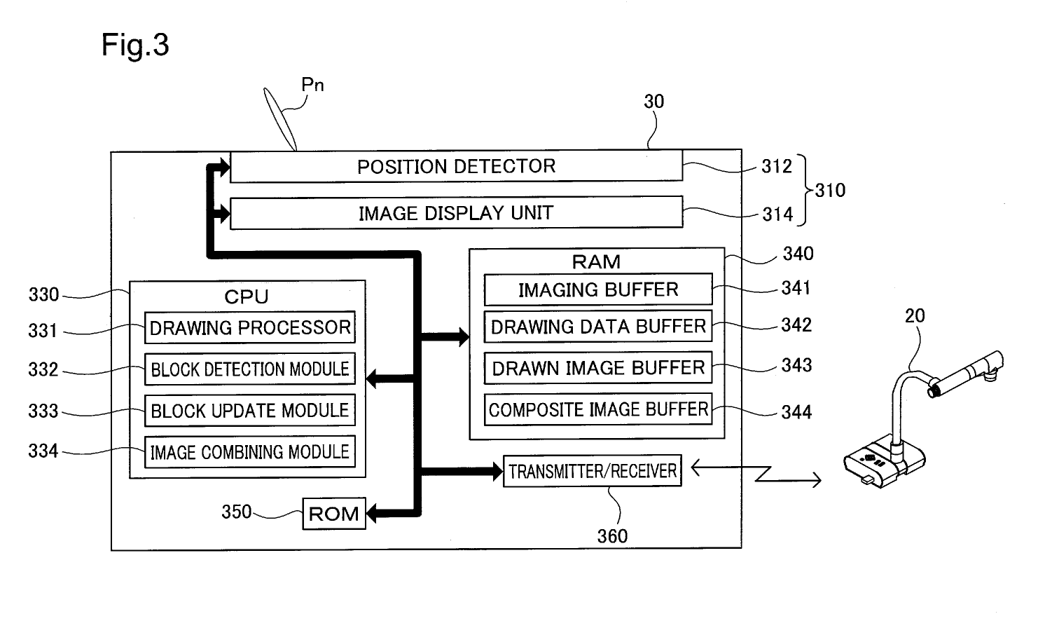

FIG. 3 is a block diagram illustrating the internal structure of the tablet 30. The tablet 30 includes a touch panel 310, a CPU 330, a RAM 340, a ROM 350 and a transmitter/receiver 360. The touch panel 310 is a capacitive projector touch panel and includes a position detector 312 for sensing a change in capacitance between the conductive film of the touch panel 310 and a tablet pen Pn or the user's finger and thereby detecting the position, and an image display unit 314 for displaying an image. The image display unit 314 includes a liquid crystal display to display the image taken by the information providing device 20 and to display the processing result (for example, cursor or drawn image) of the user's operation to the position detector 312 in real time to be superimposed on the taken image.

The CPU 330 includes a drawing processor 331, a block detection module 332, a block update module 333 and an image combining module 334, which will be described later in detail. The RAM 340 includes an imaging buffer 341, a drawing data buffer 342, a drawn image buffer 343 and a composite image buffer 344. The imaging buffer 341 stores the taken image received from the information providing device 20 during the drawn image display process described later. The drawing data buffer 342 stores a line drawing by the user's drawing operation in the form of vector data. The drawn image buffer 343 divides the line drawing by the user's drawing operation into areas of the touch panel 310 and stores the line drawing divisions of the respective areas in the form of raster data (bitmap in this embodiment). The composite image buffer 344 stores composite image data obtained by superimposing the drawn image by the user's drawing operation on the image taken by the information providing device 20. The transmitter/receiver 360 sends and receives preset data (described later) to and from the transmitter/receiver 29 of the information providing device 20.

(A2) Drawn Image Display Process

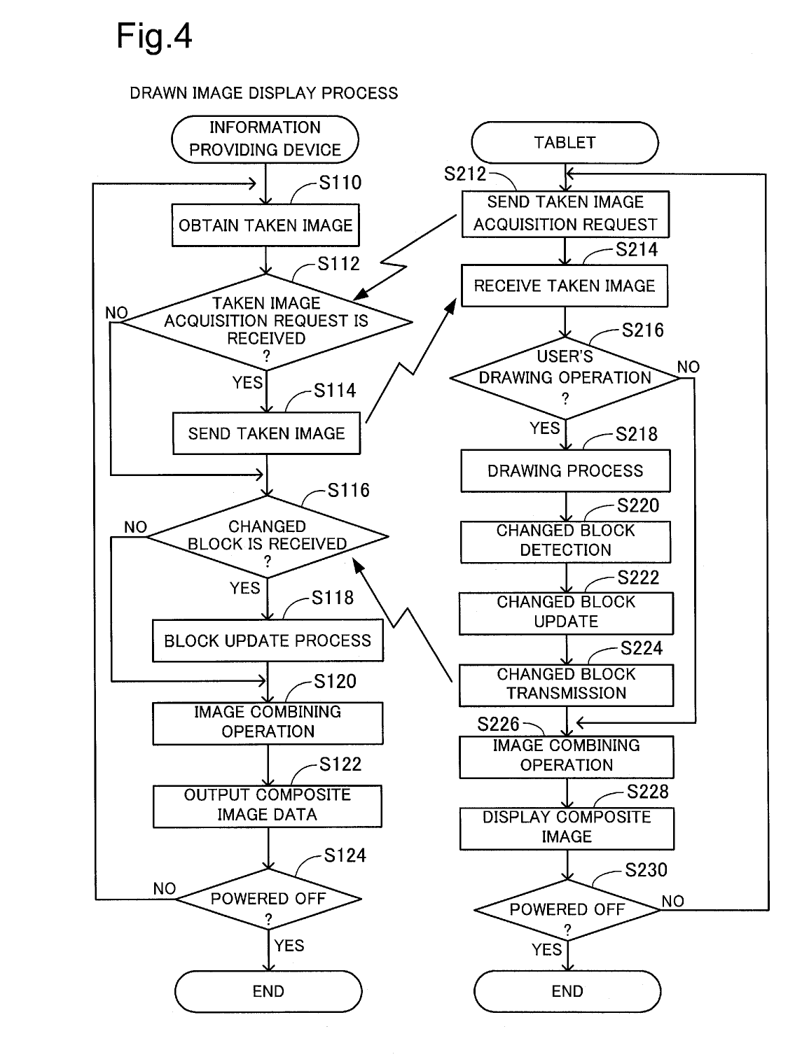

The drawn image display process performed by the information providing system 10 is described below. The drawn image display process displays a drawn image by the user's operation on the tablet 30, together with the image taken by the information providing device 20, on the touch panel 310. FIG. 4 is a flowchart showing an exemplary flow of the drawn image display process. The drawn image display process is triggered when the information providing device 20 and the tablet 30 are powered ON.

On the start of the drawn image display process, the CPU 230 of the information providing device 20 obtains a taken image of the material RS placed on the imaging area RA taken by the imaging unit 210 and generated by the imaging unit 210 and the image processing unit 220 and stores the taken image into the imaging buffer 241 (step S110). The CPU 230 subsequently determines whether an acquisition request of the taken image is received from the tablet 30 (step S112). When receiving the acquisition request of the taken image from the tablet 30 (step S112: Yes; step S212), the CPU 230 of the information providing device 20 sends the taken image to the tablet 30 (step S114), and the CPU 330 of the tablet 30 receives the taken image and stores the received taken image into the imaging buffer 341 (step S214). The CPU 330 of the tablet 30 subsequently determines whether there is any user's drawing operation on the tablet 30 (step S216). In the information providing system 10, the user performs the drawing operation while checking the image displayed on the image display unit 314 of the tablet 30. When there is no user's drawing operation (step S216: No), for example, at the time immediately after the start of the drawn image display process, the processing flow immediately goes to step S226, at which the CPU 330 starts an image combining operation to combine the taken image with the drawn image. In this case, however, there is no drawn image to be combined with the taken image, so that the taken image is substantially displayed as a composite image on the image display unit 314 (step S228). The drawn image display process by the tablet 30 is repeatedly performed until the tablet 30 is powered OFF (step S230). In the second or subsequent cycle of the drawn image display process, the taken image is displayed on the image display unit 314 of the tablet 30, so that the user performs the drawing operation while checking the displayed taken image. In the second or subsequent cycle of the drawn image display process by the tablet 30, when there is any user's drawing operation to the position detector 312 (step S216: Yes), the CPU 330 or specifically its drawing processor 331 stores a line drawing by the user's drawing operation in the form of vector data into the drawing data buffer 342 (step S218).

After storing the line drawing as the vector data, the tablet 30 sequentially performs a changed block detection process (step S220), a changed block update process (step S222) and a changed block transmission process (step S224) as described below. The CPU 230 of the information providing device 20 receives a changed block sent from the tablet 30 by the changed block transmission process (step S116) and performs a block update process (step S118). The following describes the details of these series of processing.

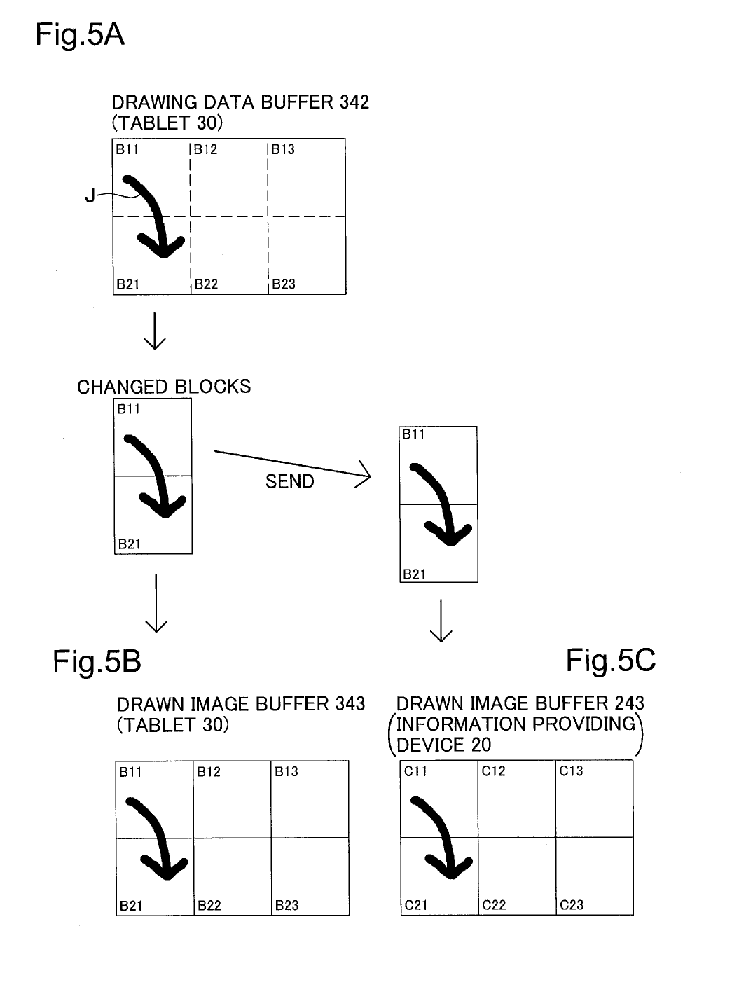

FIG. 5 illustrates the changed block detection process (step S220) to the changed block transmission process (step S224) by the tablet 30, along with the changed block reception (step S116) and the block update process (step S118) by the information providing device 20. As a concrete example, it is assumed that the user uses the tablet pen Pn to draw an arrow (drawn image J) as the drawing operation on the tablet 30.

When the user draws the drawn image J as the drawing operation to the position detector 312 of the tablet 30, the CPU 330 of the tablet 30 stores the drawn image J as a set of vector data representing short lines (hereinafter simply called “vector data”) into the drawing data buffer 342 as mentioned above. Alternatively the drawn image may be stored as a set of Bezier curves, instead of straight lines. FIG. 5A schematically shows vector data stored in the drawing data buffer 342 in correlation to the areas of the touch panel 310 (hereinafter called “panel areas PF”).

The CPU 330 subsequently converts the vector data stored in the drawing data buffer 342 into raster data and stores the raster data into the drawn image buffer 343. During this process, the CPU 330 or specifically the drawing processor 331 converts the vector data with respect to only a specified area (changed block described below) in a panel area PF into raster data and stores the converted raster data. FIG. 5B shows the drawn image buffer 343 of the tablet 30. The drawn image buffer 343 divides the panel area PF into m×n areas (hereinafter called “blocks”), which are expressed as B11, B12, . . . , B1n, B21, B22, . . . B2n, . . . , Bmn. FIG. 5A shows upper left 2×3 blocks B11, B12, B13, B21, B22 and B23. The drawn image buffer 343 stores the drawn image J in the form of raster data of the respective areas.

After storing the drawn image J as the vector data, the CPU 330 specifies the blocks having the drawn image J among the blocks B11 to B23 (step S220 in FIG. 4). In other words, during the repeated cycles of the drawn image display process, the CPU 330 detects any block having a change as the drawn image (hereinafter called “changed block”) between the changed block detection process (step S220 in FIG. 4) in the last cycle of the drawn image display process and the changed block detection process in the current cycle. In this illustrated example, the drawn image J is drawn across the blocks B11 and B12, so that the CPU 330 detects the blocks B11 and B12 as the changed blocks.

As shown in FIG. 5B, the CPU 330 converts the vector data of the changed blocks B11 and B21 into raster data and replaces the raster data of the blocks B11 and B21 previously stored in the drawn image buffer 343 with the newly converted raster data. In other words, the CPU 330 updates the raster data stored in the drawn image buffer 343 with respect to only the blocks having a change by the user's drawing operation (step S222).

While updating the raster data, the CPU 330 encodes the raster data of the changed blocks and sends the encoded raster data to the information providing device 20 (step S224). When there is no changed block irrespective of the user's drawing operation (for example, when the user rests the tablet pen Pn on the touch panel), the CPU 330 sends a vacant packet, in placed of the encoded raster data of the changed blocks. FIG. 5C shows the drawn image buffer 243 of the information providing device 20. Like the drawn image buffer 343 described above with reference to FIG. 5B, the drawn image buffer 243 stores the drawn image as raster data of the respective blocks. In the description hereinafter, the blocks in the drawn image buffer 243 of the information providing device 20 are expressed as blocks C11 to C23.

When receiving the encoded raster data of the changed blocks via the transmitter/receiver 29, the information providing device 20 decodes the encoded raster data of the changed blocks and temporarily stores the changed blocks into the received block buffer 242 (step S116: Yes). The information providing device 20 subsequently performs the block update process to replace the raster data of the blocks C11 and C21 previously stored in the drawn image buffer 243 with the raster data of the changed blocks C11 and C21 (step S118). In this manner, the information providing system 10 performs the changed block detection process (step S220) to the changed block transmission process (step S224), along with the changed block reception (step S116) and the block update process (step S118).

After the block update process, the CPU 230 of the information providing device 20 performs an image combining operation to superimpose the raster data of the blocks C11 to C23 stored in the drawn image buffer 243 on the taken image stored in the imaging buffer 241 and thereby generate a composite image (step S120). The CPU 230 or specifically its display output module 233 outputs the generated composite image to the television set 40 via the analog data output IF 274 (step S122). The CPU 230 repeats the processing of steps S110 to S122 until the information providing device 20 is powered OFF (step S124).

After updating the raster data of the changed blocks in the drawn image buffer 343 (step S222) and sending the changed blocks to the information providing device 20 (step S224), the CPU 330 of the tablet 30 performs an image combining operation to superimpose the raster data of the blocks B11 to B23 stored in the drawn image buffer 343 on the taken image stored in the imaging buffer 341 and thereby generate a composite image (step S226) and displays the generated composite image on the image display unit 314 (step S228). The CPU 330 repeats the processing of steps S212 to S228 until the tablet 30 is powered OFF (step S230).

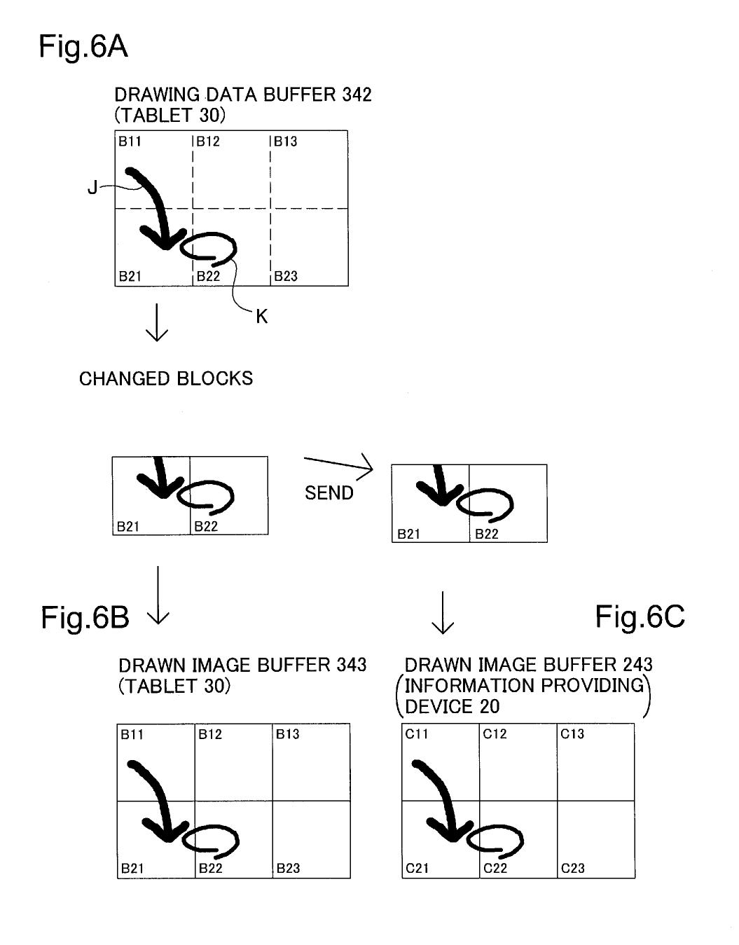

As shown in FIGS. 6A, 6B, and 6C, when the user additionally draws a curve as a drawn image K after drawing the drawn image J, the information providing system 10 updates the raster data of only the changed blocks in the drawn image buffer 343 and in the drawn image buffer 243 in the same manner as described above with respect to the drawn image J and combines the updated drawn image with the taken image to generate and display a composite image both in the information providing device 20 and the tablet 30.

As described above, the information providing system 10 performs the drawn image display process to display the taken image and the drawn image on the touch panel 310 of the tablet 30. The user can thus perform the drawing operation, while checking the displayed image at hand. This ensures the user's drawing operation with the higher accuracy and improves the user's operability of the tablet 30, compared with the case where the user operates the tablet 30 at hand while checking the displayed image on the distant display (television set 40 in this embodiment).

In the drawn image display process, the tablet 30 sends only the raster data of the changed blocks having a change by the user's drawing operation to the information providing device 20. This significantly reduces the data volume to be transmitted and improves the processing speed, compared with the case of consistently transmitting all the raster data of the panel area PF to the information providing device 20. According to this embodiment, the tablet 30 performs the changed block detection process (step S220), the changed block update process (step S222) and the changed block transmission process (step S224) in each cycle of the drawn image display process, i.e., at preset intervals. The image display unit 314 of the tablet 30 can thus display a composite image reflecting the changed drawn image in real time. The composite image is generated in the tablet 30, so that the drawn image following the user's drawing operation can be reflected in real time on the display of the image display unit 314. This prevents confusion of the user performing the drawing operation while checking the display on the touch panel 310. This also reduces the number of changed blocks transmitted each time, thus reducing the data volume transferred each time.

The information providing device 20 includes the tablet driver 232, which processes the raster data of the changed blocks directly received from the tablet 30. This does not require any separate computer for the processing, thus facilitating the user's installation, wiring and transport of the information providing system 10.

Additionally, the information providing system 10 allows for the user's drawing operation and cursor movement by using the wireless tablet 30. There is accordingly no need to use cables for connecting the tablet 30 to the information providing device 20, and there is no cable disconnection or failure.

The taken image sent from the information providing device 20 to the tablet 30 in the drawn image display process corresponds to the first information described in the claims, and the changed block sent from the tablet 30 to the information providing device 20 corresponds to the second information described in the claims. The functionalities of the image combining module 236 and the display output module 233 correspond to the display output module described in the claims. The touch panel 310 and the image display unit 314 respectively correspond to the operation unit and the image display module in Claims.

### B. Modifications

(B1) Modification 1:

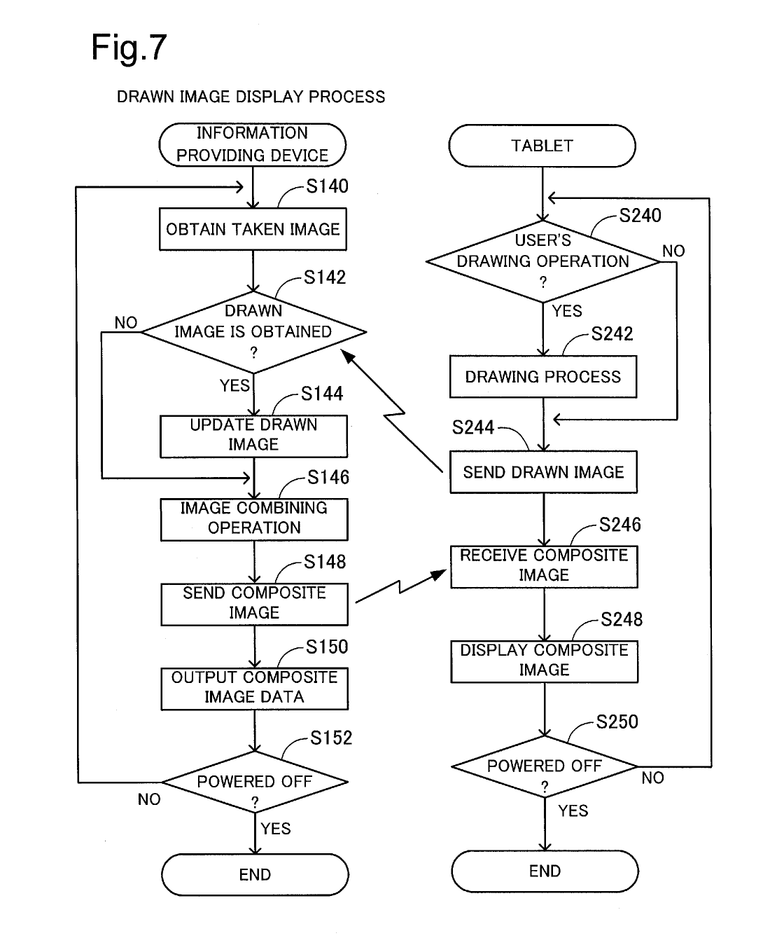

In the drawn image display process according to the above first embodiment, the information providing device 20 sends the taken image to the tablet 30, and the tablet 30 sends the changed blocks to the information providing device 20. The image combining operation is performed in both the information providing device 20 and the tablet 30. Another processing flow may be adopted to display the taken image or the composite image of the taken image with the drawn image on the touch panel 310 of the tablet 30. FIG. 7 is a flowchart showing another flow of the drawn image display process according to modification 1.

The information providing device 20 obtains a taken image (step S140) and obtains a drawn image sent from the tablet 30 at preset intervals (step S142: Yes). The drawn image sent here may be vector data or raster data of the whole drawn image. In this modification 1, the raster data is sent as the drawn image. The CPU 230 of the information providing device 20 stores the received drawn image in the form of raster data into the drawn image buffer 243 (step S144). The drawn image display process is repeatedly performed until the information providing device 20 and the tablet 30 are powered OFF. In the second or subsequent cycle of the drawn image display process, when the information providing device 20 receives a drawn image from the tablet 30, the CPU 230 updates the drawn image stored in the drawn image buffer 243.

After obtaining or updating the drawn image, the CPU 230 reads the drawn image from the drawn image buffer 243 and performs the image combining operation to superimpose the drawn image on the taken image and thereby generate a composite image (step S146). When the information providing device 20 does not obtain any drawn image received from the tablet 30 and does not have storage of the drawn image in the drawn image buffer 243 (step S142: No), the CPU 230 regards the taken image as the composite image.

The CPU 230 subsequently sends the generated composite image to the tablet 30 (step S148). Along with sending the composite image, the CPU 230 outputs the composite image to the television set 40 via the analog data output IF 274 (step S150). The CPU 230 repeats this series of processing until the information providing device 20 is powered OFF (step S152).

When there is any user's drawing operation (step S240: Yes), the tablet 30 performs the drawing process to convert the drawn image into raster data and store the raster data into the drawn image buffer 343 (step S242) and subsequently sends the drawn image in the form of raster data to the information providing device 20 (step S244). The CPU 330 receives the composite image of the taken image and the drawn image combined by the information providing device 20 from the information providing device 20 (step S246) and displays the received composite image onto the image display unit 314 (step S248). The CPU 330 repeats this series of processing until the tablet 30 is powered OFF (step S250). When there is no user's drawing operation (step S240: No), on the other hand, the tablet 30 sends a vacant frame image without a line drawing as the drawn image to the information providing device 20 (step S244).

According to this flow of the drawn image display process described with reference to FIG. 7, the taken image or the composite image of the taken image with the drawn image can be displayed on the touch panel 310 of the tablet 30.

(B2) Modification 2:

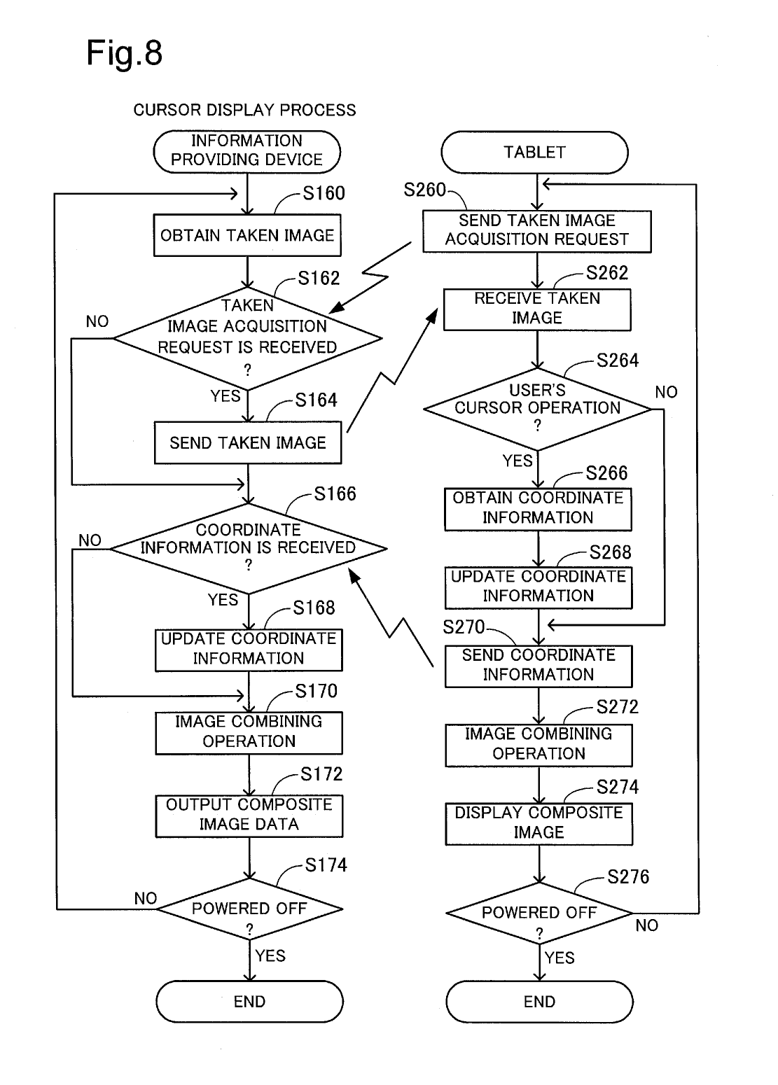

The series of processing in relation to the user's drawing operation is described in the above first embodiment. According to another embodiment, when the user performs a cursor operation to move the cursor by the operation on the tablet 30, the information providing device 20 may display the cursor movement with the taken image on the television set 40, while the tablet 30 may display the cursor movement with the taken image on the image display unit 314 as described below. FIG. 8 is a flowchart showing an exemplary flow of cursor display process performed in the information providing system 10. As in the drawn image display process of the first embodiment, in the cursor display process, the tablet 30 sends an acquisition request of the taken image to the information providing device 20 (step S260) and obtains the taken image (step S262). When there is any user's cursor operation to move the cursor (step S264: Yes), the position detector 312 detects the coordinates of the cursor position specified on the touch panel 310 by the user at preset intervals (60 Hz in this embodiment), and the CPU 330 obtains the detected coordinates as coordinate information and stores the coordinate information into the RAM 340 (step S266). When obtaining the coordinate information, the CPU 330 updates the coordinate information stored in the RAM 340 (step S268) and sends the coordinate information stored in the RAM 340 to the information providing device 20 (step S270). After sending the coordinate information, the CPU 330 performs an image combining operation to superimpose the cursor image at the coordinate position corresponding to the coordinate information on the taken image and thereby generate a composite image (step S272) and displays the generated composite image on the image display unit 314 (step S274).

The CPU 230 of the information providing device 20 obtains a taken image (step S160), receives the acquisition request of the taken image (step S162: Yes), sends the taken image (step S164), receives the coordinate information from the tablet 30 (step S166) and stores and updates the coordinate information in the RAM 240 (step S168). The CPU 230 subsequently performs an image combining operation to superimpose the cursor image at the coordinate position corresponding to the coordinate information on the taken image and thereby generate a composite image (step S170) and displays the generated composite image on the television set 40 via the analog data output IF 274 (step S172).

The information providing system 10 performs the above series of processing to display the composite image of the cursor image with the taken image on the touch panel 310 when the user operates the tablet 30 to move the cursor. This improves the user's operability of the tablet 30.

(B3) Modification 3:

In the drawn image display process (FIG. 4) of the first embodiment described above, the tablet 30 performs the detection of the changed blocks (step S220), the update of the changed blocks (step S222) and the transmission of the changed blocks (step S224) in each cycle of the drawn image display process, i.e., at preset intervals. According to another embodiment, the tablet 30 may send a first changed block where the user first makes drawing, at the timing when the drawn image by the user's drawing operation crosses over a next changed block. In this case, reducing the size of each block, i.e., dividing the panel image PA into a greater number of blocks (subdivision of blocks) enables the composite image reflecting the changed drawn image to be displayed at the real time-like timing on the image display unit 314 of the tablet 30. The size reduction of each block to be smaller than the block size of the first embodiment decreases the data volume to be sent each time.

According to still another embodiment, the tablet 30 may perform the detection of the changed blocks (step S220), the update of the changed blocks (step S222) and the transmission of the changed blocks (step S224) at preset intervals, along with such subdivision of blocks to the smaller block size than that of the first embodiment. This enables the composite image reflecting the changed blocks to be displayed in real time on the image display unit 314, while reducing the data volume to be transferred.

According to another embodiment, the tablet 30 may send the changed blocks to the information providing device 20 at the timing when the user separates the tablet pen Pn from the position detector 312. As described above, the tablet 30 may perform the detection of the changed blocks (step S220), the update of the changed blocks (step S222) and the transmission of the changed blocks (step S224) at various timings.

(B4) Modification 4:

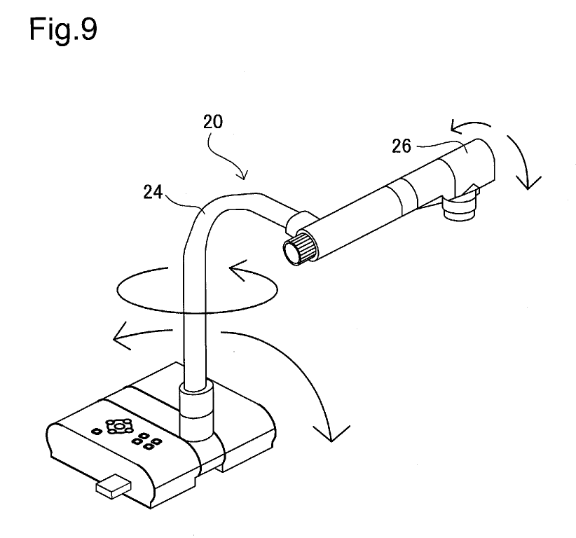

The information providing device is not limited to the information providing device 20 of the first embodiment described above with reference to FIG. 1 but may be any of information providing devices of various other structures. For example, the information providing device may be equipped with a material table on which the material RS is placed or may be integrated with a display (for example, projector) for displaying taken images. As shown in FIG. 9, the attachment structure of the camera head 26 may be designed to be rotatable about an axis, and the support rod 24 may be designed to be rotatable about two axes.

(B5) Modification 5:

In addition to the structure of the first embodiment, when the user manipulates the zoom dial 27 (FIG. 1) to display a magnified image of the material RS on the display (television set 40 in the embodiment), the taken image of the material RS displayed on the image display unit 314 of the tablet 30 may also be magnified to increase the resolution of the user's drawing operation on the tablet 30. The information providing device 20 may send the magnification percentage or the reduction percentage set by the zoom dial 27 to the tablet 30, and the CPU 330 of the tablet 30 may vary the resolution of the drawn image by the user's drawing operation, according to the magnification percentage or the reduction percentage.

(B6) Modification 6:

The liquid crystal display is used for the image display unit 314 of the first embodiment. The liquid crystal display is, however, not essential but may be replaced with various other image display means, such as an organic EL panel or an electronic paper, to have the similar advantageous effects to those of the first embodiment. A projector mounted on the ceiling may be used as the image display unit 314 to project a displayed image at the user's hand. In this case, the position detector 312 may include a camera for sensing the motion of the tablet pen Pn or the user's finger and detect the position on the displayed image specified by the user or detect the user's drawing operation by reading the motion of the tablet pen Pn or the user's finger.

(B7) Modification 7:

The capacitive projector touch panel is used for the touch panel 310 of the first embodiment. The capacitive touch panel is, however, not essential but may be replaced with various other types of touch panels, for example, resistive touch panel, surface acoustic wave touch panel, electromagnetic induction touch panel, or video analysis touch panel. For example, in the resistive touch panel of the tablet 30 where one of two transparent electrodes has electric resistance, a voltage is applied to one of the two opposing transparent electrodes. When the two electrodes come into contact with each other by the user's operation, the position of electric continuity of the two electrodes is detected as a voltage change.

(B8) Modification 8:

According to the above embodiment, the television set 40 is used as the display for displaying images. The display is, however, not limited to this embodiment but may be any other suitable display, such as a projector or a liquid crystal display. These variants also ensure the similar advantageous effects to those of the embodiment described above.

(B9) Modification 9:

According to the above first embodiment, the information providing system 10 includes one television set 40 and one tablet 30. This is, however, not restrictive, but the information providing system 10 may include a plurality of displays, a plurality of tablets 30, or both a plurality of displays and a plurality of tablets 30. In the information providing system including a plurality of the tablets 30, each of which is identifiable by a wireless USB address or an ID assigned to each tablet, the information providing device may process the signals received from the respective tablets 30 in time-sharing manner as separate sets of operating information regarding different drawing operations on the respective tablets 30. According to a preferable embodiment, the processing results of the operating information received from the respective tablets 30 may be displayed discriminatively in different forms for the respective tablets, for example, different colors, different thicknesses or different densities of lines. In the field of education, for example, such discriminative display allows for the new form of a lesson that enables a number of students to individually operate the tablets 30 and perform the drawing operations on the displayed image.

According to another embodiment, the information providing device 20 may be designed to have a selecting switch for selecting which of the plurality of tablets is to be valid. According to yet another embodiment, the information providing device 20 may be designed to have a prohibiting switch for prohibiting the display of the processing results, while the plurality of tablets are all valid. In the latter case, the processing may continue even during the display prohibiting period, and the processing results may be displayed simultaneously after the prohibition is dismissed. For example, the display of the processing results may be prohibited, while the individual students are giving responses to make drawing. The responses of all the students may simultaneously be displayed later. According to still another embodiment, the color of the selecting switch used for selecting tablets may be set to be identical with the color of drawing. This facilitates the selection of tablets, thus improving the user's convenience.

In the information providing system including a plurality of displays, the information providing device 20 has a plurality of the digital data output IFs 272 and a plurality of the analog data output IFs 274, to which the plurality of displays are connected. The same taken image or the same composite image of the taken image with the drawn image may be displayed on the plurality of displays. Alternatively one image may be divisionally displayed by the plurality of displays (for example, projectors), and one integral displayed image may be formed from a plurality of divisional displayed images. In the latter case, the information providing device 20 includes an image divider for dividing an image to be displayed into divisional images and an output processor to output the divisional images synchronously to the respective output IFs.

(B10) Modification 10:

Part of the functions implemented by the software configuration in the above embodiment may be implemented by the hardware configuration, whilst part of the functions implemented by the hardware configuration in the above embodiment may be implemented by the software configuration.

The foregoing has described the invention in detail with reference to the illustrative embodiment and modifications. The invention is, however, not limited to the above embodiment and modifications, but a multiplicity of other variants and modifications may be made to the embodiment without departing from the scope of the invention.

What is claimed is:

1. An information providing system including an information providing device and a tablet terminal,
the information providing device comprising:
a single housing;
an imaging unit configured to take an image with a camera and obtain the taken image;
a first information transmitter configured to wirelessly send first information including the taken image, to the tablet terminal;
a second information receiver configured to wirelessly receive second information including information regarding a user's drawing operation on the table terminal, from the table terminal; and
a display output module configured to display a drawn image corresponding to the user's drawing operation to be superimposed on the taken image, as a displayed image on a display, based on the second information, wherein
the imaging unit, the first information transmitter, the second information receiver and the display output module are all accommodated in the single housing,
the tablet terminal comprising:
an operation unit having an operating surface, on which the user performs the drawing operation;
a second information transmitter configured to wirelessly send the second information to the information providing device, based on the user's drawing operation;
a first information receiver configured to wirelessly receive the first information from the information providing device; and
an image display module configured to display a tablet displayed image, which includes the drawn image superimposed on the taken image, on the operating surface, based on the first information.

2. The information providing system according to claim 1, wherein
the second information transmitter sends the drawn image as the second information to the information providing device,
the image display module comprises a tablet displayed image generator configured to generate a composite image including the drawn image superimposed on the taken image, as the tablet displayed image,
the information providing device further comprises a received drawn image storage configured to store the drawn image received by the second information receiver, and
the display output module comprises a displayed image generator configured to generate a composite image including the drawn image superimposed on the taken image, as the displayed image.

3. The information providing system according to claim 2, wherein
the tablet displayed image generator comprises:
a block image storage configured to divide each area of the operating surface into a plurality of blocks and store the drawn image as a set of block images of the respective blocks; and
a tablet block updater configured to update a block image for a changed block having a change of the drawn image by the user's drawing operation, which is stored in the block image storage, to a corresponding changed block image reflecting the change, wherein
the second information transmitter sends a block image for the changed block as the second information to the information providing device,
the received drawn image storage stores the drawn image as a set of the block images, and
the information providing device further comprises an information providing device block updater configured to, in response to reception of a block image as the second information, update the drawn image stored in the received drawn image storage, based on the received block image.

4. The information providing system according to claim 3, wherein
the first information transmitter sends the first information to the tablet terminal, in response to an acquisition request of the first information from the tablet terminal, and
the second information transmitter sends the block image for the changed block as the second information to the information providing device, occasionally when the drawn image is changed by the user's drawing operation.

5. An information providing device configured to work with a tablet terminal, the information providing device comprising:
a single housing within which is accommodated;
an imaging unit configured to take an image with a camera and obtain the taken image;
a first information transmitter configured to wirelessly send first information including the taken image, to the tablet terminal;
a second information receiver configured to wirelessly receive second information including information regarding a user's drawing operation on the table terminal, from the table terminal; and
a display output module configured to display a drawn image corresponding to the user's drawing operation to be superimposed on the taken image, as a displayed image on a display, based on the second information; and
an image display module configured to display a tablet displayed image, which includes the drawn image superimposed on the taken image, based on the first information.

6. A tablet terminal configured to work with an information providing device comprising:
an operation unit having an operating surface, on which a user may perform a drawing operation;
a second information transmitter configured to wirelessly send a second information to the information providing device, based on the user's drawing operation;
a first information receiver configured to wirelessly receive a first information from the information providing device.

7. The information providing device of claim 5, wherein
the image display module comprises a tablet displayed image generator configured to generate a composite image including the drawn image superimposed on the taken image, as the tablet displayed image,
the information providing device further comprises a received drawn image storage configured to store the drawn image received by the second information receiver, and
the display output module comprises a displayed image generator configured to generate a composite image including the drawn image superimposed on the taken image, as the displayed image.

8. The information providing device according to claim 7, wherein
the tablet displayed image generator comprises:
a block image storage configured to divide each area of an operating surface of the tablet terminal into a plurality of blocks and store the drawn image as a set of block images of the respective blocks; and
a tablet block updater configured to update a block image for a changed block having a change of the drawn image by the user's drawing operation, which is stored in the block image storage, to a corresponding changed block image reflecting the change, wherein
a second information transmitter in the tablet terminal sends a block image for the changed block as the second information to the information providing device,
the received drawn image storage stores the drawn image as a set of the block images, and
the information providing device further comprises an information providing device block updater configured to, in response to reception of a block image as the second information, update the drawn image stored in the received drawn image storage, based on the received block image.

9. The information providing device according to claim 8, wherein
the first information transmitter sends the first information to the tablet terminal, in response to an acquisition request of the first information from the tablet terminal.

10. The tablet terminal of claim 6, the operating surface of the tablet terminal comprising a plurality of blocks and a drawn image a set of block images of the respective blocks wherein the second information transmitter sends a block image for the changed block as the second information to the information providing device when the drawn image is changed by the user's drawing operation.
